(19) United States
(12) Patent Application Publication
(10) Pub. No.: US 2024/0325965 A1
(43) Pub. Date: Oct. 3, 2024

(54) DIRECT AIR CAPTURE OF CARBON DIOXIDE

(71) Applicant: THE REGENTS OF THE UNIVERSITY OF CALIFORNIA, Oakland, CA (US)

(72) Inventors: Fabian Rosner, Los Angeles, CA (US); Hanna Breunig, El Cerrito, CA (US)

(73) Assignee: THE REGENTS OF THE UNIVERSITY OF CALIFORNIA, Oakland, CA (US)

(21) Appl. No.: 18/622,861

(22) Filed: Mar. 29, 2024

Related U.S. Application Data
(60) Provisional application No. 63/493,390, filed on Mar. 31, 2023.

(51) Int. Cl. B01D 53/14; B01D 53/18

(52) U.S. Cl. CPC B01D 53/1475; B01D 53/1493; B01D 53/18; B01D 2252/20405; B01D 2252/20421; B01D 2252/20484; B01D 2252/602; B01D 2257/504; B01D 2258/06

(57) ABSTRACT

A system for direct air capture (DAC) of carbon dioxide uses a liquid CO₂-absorbent solvent that enables the hybridization of a cooling tower with CO₂ DAC systems. A liquid solvent such as monoethanolamine (MEA) is added to cooling water to absorb CO₂ from ambient air, the cooling water is used for its original purpose, and CO₂ is recovered from the cooling water in a novel process. Initially, this combination of CO₂ absorbent and cooling water would appear to be undesirable, since liquid CO₂ solvents such as MEA are hygroscopic, and cooling towers reject heat via evaporation. However, an absorbent concentration range was identified where CO₂ could be still absorbed and water evaporated, and a novel process for absorbent solvent regeneration was created.

### CROSS-REFERENCE TO RELATED APPLICATIONS

This application claims priority to, and the benefit of, U.S. provisional patent application Ser. No. 63/493,390 filed on Mar. 31, 2023, incorporated herein by reference in its entirety.

### STATEMENT REGARDING FEDERALLY SPONSORED RESEARCH OR DEVELOPMENT

This invention was made with government support under Contract No. DE-AC02-05CH11231 awarded by the U.S. Department of Energy. The government has certain rights in this invention.

### BACKGROUND

### 1. Technical Field

The technology of this disclosure pertains generally to direct air capture (DAC) of CO₂, and more particularly to direct air capture (DAC) of carbon dioxide in a new or modified water cooling tower.

### 2. Background Discussion

Cooling towers are typically found in a variety of industrial installations, from heating ventilation and air conditioning (HVAC) to a variety of industrial process, to geothermal power plants. These extant cooling towers, however, do nothing regarding carbon capture and fail to address in any way the world-wide issue of increasing atmospheric CO₂ concentrations leading to global warming. One method of reducing atmospheric CO₂ concentrations is carbon sequestration.

### BRIEF SUMMARY

This disclosure generally describes systems and methods for direct air capture (DAC) of carbon dioxide. Embodiments include system integration schemes and liquid CO₂-absorbent solvents that enable the hybridization of cooling tower and DAC systems. In some embodiments, a liquid absorbent solvent (e.g., monoethanolamide (MEA)) is added to cooling water to form a coolant in a process to absorb CO₂ from ambient air. The coolant is then used for its original purpose, and CO₂ is recovered from the coolant in a recovery process.

This combination of CO₂ solvent and cooling water might appear to be undesirable because liquid CO₂ solvents such as MEA are hygroscopic and cooling towers reject heat via evaporation. Here, it is shown that an solvent concentration range is available where CO₂ can be still absorbed and water evaporated. Additionally, a process for regenerating a CO₂-enriched solvent stream is shown.

Included herein are process flow diagrams and analysis of a geothermal power plant, but the methodology can be used at other facilities with cooling towers too, in a similar fashion.

As cooling towers are a requirement at geothermal facilities, the capital and operating expenses of the described cooling tower DAC of CO₂ absorption system are significantly reduced, with cost-of-capture as low as $100 per ton of captured CO₂, which is the United States (U.S.) Department of Energy (DOE) target for DAC systems, compared with commercialized approaches $500-$1000 (current DAC systems).

Details of one or more embodiments of the subject matter described in this specification are set forth in the accompanying drawings and the description below. Other features, aspects, and advantages will become apparent from the description, the drawings, and the claims. Note that the relative dimensions of the following figures may not be drawn to scale.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE DRAWINGS

The technology described herein will be more fully understood with reference to the following drawings, which are for illustrative purposes only:

FIG. 1A, FIG. 1B, and FIG. 1C together form a diagram of the process flow of a geothermal power plant where direct air capture (DAC) of carbon dioxide has been incorporated in part into a modified cooling tower.

FIG. 2 is a common cooling tower used in a conventional industrial application.

FIG. 3 is a partial cross section of a direct air capture (DAC) of carbon dioxide system integrated into a cooling tower with a solvent retention system in a counterflow configuration.

FIG. 4 illustrates a design of a direct air capture (DAC) of carbon dioxide hybrid cooling tower with an added horizontal solvent retention system in a crossflow configuration.

FIG. 5 illustrates a design of a direct air capture (DAC) of carbon dioxide hybrid cooling tower modified to incorporate an inclined solvent retention system in a crossflow configuration.

### DETAILED DESCRIPTION

### Introduction

Conventional cooling towers operate with only one fluid (cooling water). This coolant fluid is brought into contact with air, commonly in a counter-flow or cross-flow arrangement, to evaporate water, which leads to cooling of the fluid/cooling water because evaporating water requires thermal energy. The overall process is referred to as direct air capture (DAC). Because the airflow might entrain some water droplets, cooling towers might employ a mist eliminator, typically comprised of mesh or vanes. Because of this evaporative water loss, makeup cooling water is added to the catchment basin of the cooling tower to maintain sufficient coolant volume. The cooling water makeup does not fundamentally differ from the cooling water itself, which is already circulating in the cooling tower.

In this invention, a liquid solvent is added to the fluid/cooling water. This has the advantage that when ambient air is brought into contact with the coolant fluid in the cooling tower, not only does it produce the cooling effect needed for the function of the cooling tower, but it can also, simultaneously, capture CO₂ from the ambient air. The downside of using a liquid carbon dioxide solvent (such as amines) in this application is that amines are hygroscopic (amine solutions attract water rather than evaporate/lose water) and have a vapor pressure (solvents want to evaporate). As disclosed herein, these challenges have been overcome by: 1) identifying solvent concentrations that allow for concurrent water evaporation and CO₂ capture, 2) an efficient way of regenerating the solvent in these unconventional concentration ranges, and 3) by installing a solvent retention system directly in the cooling tower to recover evaporated solvent.

In an alternate embodiment, such a system may be integrated into a geothermal power plant, where the cooling tower design advantageously integrates with this invention, e.g. blowdown management.

### Solvent Retention System

When a liquid CO₂-capture solvent is added to the fluid/cooling water coolant solution, and operated in a cooling tower, air comes into contact with the coolant solution in a contactor bed. Due to the contact of ambient air with the solvent-added cooling solution, the following things occur: 1) water evaporates and humidifies the ambient air (the cooling effect); 2) CO₂ is absorbed into the coolant solution (a desirable CO₂ capture effect); and 3) some of the liquid solvent evaporates and also ends up as gas in the ambient air (which is undesirable for economic and environmental reasons). While conventional cooling towers have a mist eliminator downstream of the contactor bed to capture droplets entrained in the air flow, the mist eliminator cannot retain the gaseous/evaporated solvent. To recover the gaseous solvent in the air, a solvent retention system is installed downstream (in terms of air flow, not water flow) of the contactor bed where the solvent-added cooling water is in contact with the ambient air (because this is where the air carries some of the evaporated solvent).

### Solvent Recovery

To recover the gaseous solvent from the air stream, the air stream needs to be brought into contact with a substantially solvent-free liquid. Conveniently, pure (or substantially solvent-free) water can be used that can simultaneously act as cooling water makeup (to operate the unit a CO₂-solvent makeup is also needed, but any CO₂-solvent makeup is added to the cooling tower basin similar to the makeup in conventional cooling towers). To bring the solvent-free liquid in contact with the air leaving the contactor bed a spray nozzle system may be installed downstream of the contactor bed. The goal is to create a large surface area for mass transfer, additionally a contactor bed/packing specifically for the retention system may or may not be used. To eliminate droplet entrainment from the solvent retention system, mist eliminators comprised of mesh and/or vanes may be employed. If a mist eliminator is installed as part of the solvent retention system, it may render the mist eliminator upstream of the solvent retention system (if one is installed) obsolete, thereby enabling cost savings.

Reference will now be made in detail to some specific examples of the invention, including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. To the contrary, it is intended to cover alternatives, modifications, and equivalents as may be included within the spirit and scope of the invention as defined by the appended claims.

In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention, e.g. typical geothermal power plant thermodynamic operation.

Various techniques and mechanisms of the present invention will sometimes be described in singular form for clarity. However, it should be noted that some embodiments include multiple iterations of a technique or multiple instantiations of a mechanism unless noted otherwise.

The terms “about” or “approximate” and the like are synonymous and are used to indicate that the value modified by the term has an understood range associated with it, where the range can be ±20%, ±15%, ±10%, ±5%, or ±1%. The terms “substantially” and the like are used to indicate that a value is close to a targeted value, where close can mean, for example, the value is within 80% of the targeted value, within 85% of the targeted value, within 90% of the targeted value, within 95% of the targeted value, or within 99% of the targeted value.

Embodiments described herein include a DAC system to directly capture CO₂ from ambient air and produce a highly concentrated CO₂ stream that can be subsequently utilized or sequestered using the same equipment that could process CO₂ captured at a geothermal facility from off-gassing of brine waters as further described below. In order to remove CO₂ from air, where CO₂ is present in very small concentrations, large quantities of air are brought into contact with a CO₂ capture medium. This is often achieved with fans and/or large pumps. Many current DAC systems are designed for the sole purpose of capturing CO₂ from air and do not share equipment, leading to high investment costs and energy consumption, which results in a high cost-of-capture. Further, current DAC systems use large quantities (at high concentration) of the capture medium. Lower concentrations of the capture medium are desirable to reduce absorbent losses into the environment and reduce operating cost. Described herein is a process design where very low concentrations of already commercialized liquid solvents of carbon dioxide or novel liquid absorbents can be used to leverage the high liquid to gas ratio found in existing cooling tower equipment for high CO₂ removal rates.

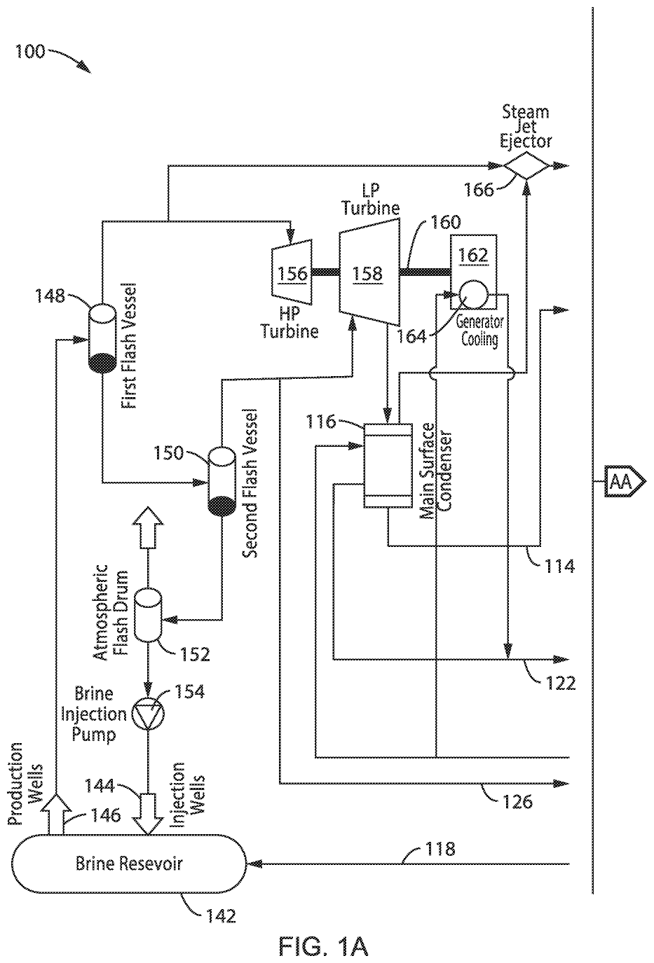

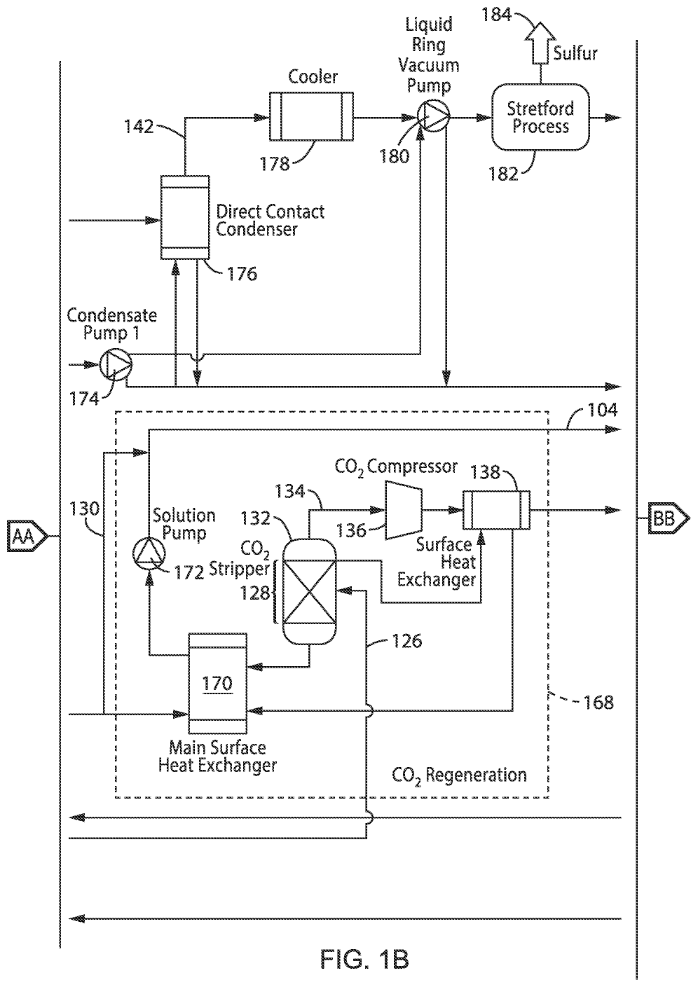

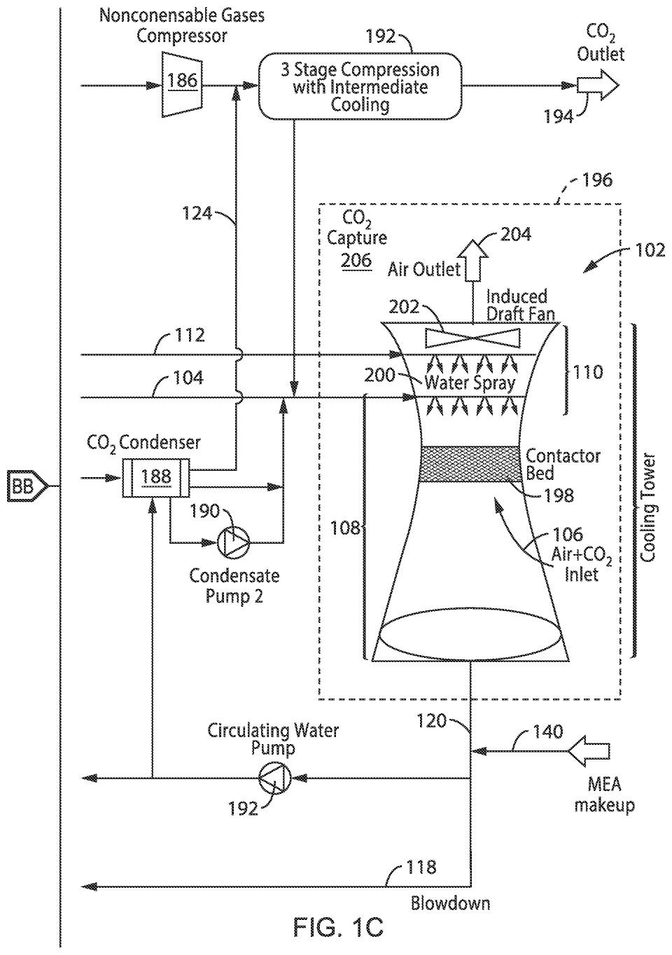

In general, a cooling tower is an industrial process unit where large quantities of air are already being moved to drive evaporative cooling (as shown below in FIG. 1A, FIG. 1B, and FIG. 1C). Initially this combination of cooling tower and DAC seems counter intuitive because CO₂ absorbents are hygroscopic, meaning that they like to absorb water. This is the opposite of what is needed in a cooling tower where cooling is achieved via evaporation of water. Here, absorbent concentrations that promote CO₂ capture while allowing water to evaporate are disclosed. An important technical challenge resulting from using low concentrations of absorbents was the need to design a new regeneration process to recover CO₂.

Described herein is a process where cooling towers at geothermal facilities can be hybridized with the disclosed DAC system to take advantage of shared capital expenses (CAPEX) and operating expenses (OPEX). Some elements of the process are the compound mixtures and thermodynamics that allow for energy efficient CO₂ capture and absorbent regeneration that result in a minimum amount of absorbent material and capital equipment.

Refer now to FIG. 1A, FIG. 1B, and FIG. 1C, which together form a diagram 100 of the process flow of a geothermal power plant where direct air capture (DAC) of CO₂ has been incorporated in part into a modified cooling tower. An embodiment of the direct air capture (DAC) of CO₂ process is as follows:

1. A liquid CO₂ solvent (e.g., MEA) is directly added to cooling water used at geothermal facilities prior to it being recirculated and returned to the cooling tower 102 to create an absorbent-rich solvent 104 for CO₂ (stream 106 includes atmospheric air and CO₂) capture.

2. When the solvent-containing cooling water (stream 104) is returned to the cooling tower 102, the solvent is exposed to ambient air (stream 106) in the cooling tower 102 and is able to absorb CO₂ from the air.

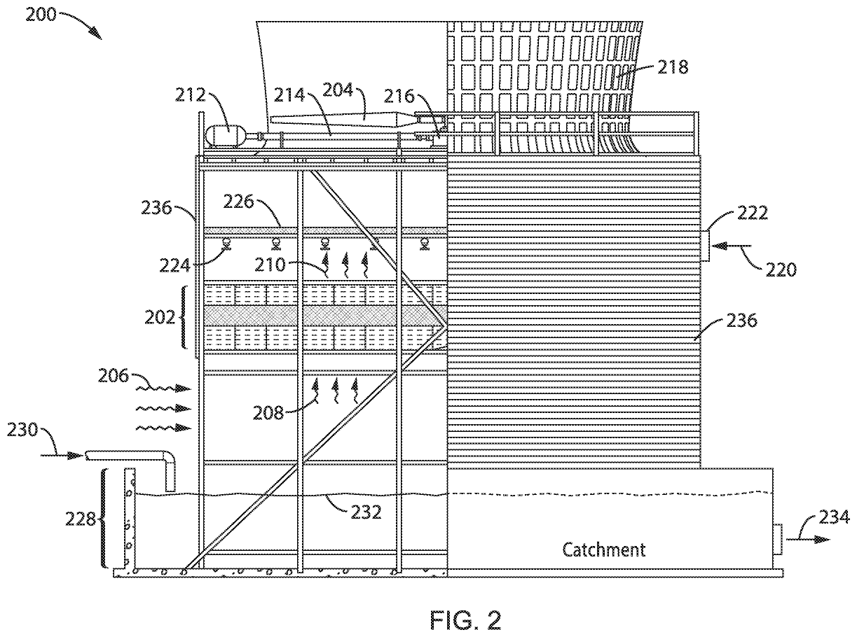

3. The CO₂ solvent is a liquid with a vapor pressure. So, to minimize solvent evaporation losses, the cooling tower 102 is redesigned with a solvent retention system comprised of a fluid injection system installed above the cooling water injection system. The lower level 108 of the cooling tower is where the absorbent-containing cooling water (stream 104) is added. The top level 110 is where substantially solvent-free cooling tower makeup water (stream 112) is added. This allows the system to recapture some of the absorbent due to the solvent's hygroscopic nature. In this embodiment, the stream 112 is steam cycle condensate. In conventional cooling towers (shown below in FIG. 2), makeup water is typically added to the cold-water catchment basin (at the bottom of the lower level 108). Using clean water as cooling tower 102 makeup water 112, e.g., steam cycle condensate (stream 114 from main surface condenser 116) or alternatively any treated water source (e.g., filtered, softened, or dimineralaized water), allows one to increase the number of cycles of concentration in the cooling tower 102 and minimize blowdown (stream 118), which is associated with loss of CO₂-absorbent solvent.

Blowdown is a cooling water purge stream necessary to limit the buildup of trace components in the cooling water that could otherwise lead to fouling. The operating conditions of this hybrid system are different from conventional operating conditions found in absorbent CO₂ capture systems, e.g., flue gas CO₂ capture systems, employed in coal fired power plant or other direct air CO₂ capture technologies, because of the different liquid to air ratio found in cooling towers.

4. When the cooling water with the CO₂-rich solvent leaves the cooling tower (stream 120) it can be used like normal cooling water for most applications. Limitations do exist, however, for direct contact heat exchangers/condensers where CO₂ is present in the gas stream where it is not desired to absorb this CO₂, or where heat exchanger surfaces exceed the solvent decomposition temperature.

5. After cooling (stream 122), the water is then regenerated and a highly concentrated CO₂ flow (stream 124) is obtained (>97 wt. % before compression and dehydration; >99 wt.-% after compression). This CO₂ can be compressed and dehydrated for storage, transport, or injection underground, ultimately leading to a desirable goal of carbon sequestration.

6. The regeneration of the CO₂ absorbent for this specific low concentration range proposed herein is challenging, but a process to achieve absorbent regeneration has been developed here:

a. Direct steam injection (stream 126) is used to eliminate reboiler and maximize energy entering the regenerator column 128, which operates as a CO₂ stripper.

b. Only treat part of the cooling water (bypass stream 130) but use a higher regeneration temperature (treat less but under more extreme conditions), which is more efficient due to the non-linear behavior of vapor pressure curves.

c. Use a “vapor compression cycle” for the overhead product (vapor leaving the regenerator column 128 on the top 132) (stream 134). In this process the overhead product is compressed 136 resulting in an increase in the dew point temperature of the overhead product. This allows the recovery of large amounts of latent heat in a downstream heat exchanger 138 that can be used to heat the feed stream entering the regenerator column 128. Without this design, the partial pressure of steam would be too low to achieve any preheating using latent heat, which is a substantial energy loss in the regenerator column 128.

7. The regenerated solvent in the cooling water is now ready to absorb CO₂ again and is returned to the cooling tower 102 (stream 104).

8. Some solvent 140 is added to replace losses over time.

The preceding description shows how a traditional geothermal power plant may be modified to add direct air capture (DAC) of carbon dioxide. Elements of the traditional geothermal power plant are not further described, but include:

Brine Reservoir 142
Injection Wells 144
Production Wells 146
First Flash Vessel 148
Second Flash Vessel 150
Atmospheric Flash Drum 152
Brine Injection Pump 154
High Pressure Turbine 156
Low Pressure Turbine 158
Drive Shaft 160
Generator 162
Generator Cooling Pump 164
Steam Jet Ejector 166
CO₂ Regeneration Section 168
Main Surface Heat Exchanger 170
Solution Pump 172
Condensate Pump 1 174
Direct Contact Condenser 176
Cooler 178
Liquid Ring Vacuum Pump 180
Stetford Process 182
Sulfur Output Stream 184
Noncondensable Gases Compressor 186
CO₂ Condenser 188
Condensate Pump 2 190
3-Stage Compression with Intermediate Cooling 192
CO₂ Outlet 194
Cooling Tower 196
Contactor Bed 198
Water Spray 200
Induced Draft Fan 202
Air Outlet 204
CO₂ Capture 206

The integration of this system into a geothermal facility is attractive. The blowdown of cooling towers at power plants other than geothermal facilities is typically discharged into the environment. Thus, chemicals used in the cooling tower need to be environmentally benign or the blowdown has to be treated to become environmentally benign. In the case of a geothermal facility, this limitation does not exist, as the cooling tower discharge is reinjected into the underground geothermal reservoir where the absorbent is expected to thermally decompose rapidly. Further, the steam cycle in a power plant, which is responsible for the electricity generation, is a once-through process, rather than a truly closed loop steam cycle, which means that the steam condensate is freely available for other users inside the plant and can be used as a direct heat source (steam injection into the cooling water), and simultaneously as additional cooling tower makeup. Further, steam extracted from the steam cycle and added to the cooling water during the regeneration process is not an extra penalty on the water side, as the condensate is typically used as cooling water makeup at geothermal facilities.

Another advantage is that geothermal facilities have a small, relatively pure CO₂ waste stream (stream 142) that is commonly vented into the atmosphere because it would be too expensive to capture on such a small scale; however, using DAC at geothermal facilities will allow for the co-capture of this stream at a significantly lower cost. After adding an initial compression stage this CO₂ stream can be made available at the same pressure as the CO₂ from the DAC system, and then can be compressed and dehydrated together with the CO₂ from the DAC system.

In addition to identifying the unique concentrations and

thermodynamics that would make air-liquid CO₂ capture energy and material efficient, the technical and economic aspects of this innovation were studied using process analysis tools. In the example FIG. 1A, FIG. 1B, and FIG. 1C process diagram and analysis, the technology uses MEA as the absorbing solvent and is integrated into a conventional dual-flash geothermal powerplant and economically benchmarked against a state-of-the-art geothermal facility.

One conventional geothermal power plant has a net 50 MW design, which produces electricity at a cost of $66.59/MWh. After integrating the DAC system into a geothermal facility, the cooling tower becomes a hybrid system as illustrated in FIG. 1A, FIG. 1B, and FIG. 1C. With this hybrid cooling tower-DAC system the geothermal facility is able to remove CO₂ from the atmosphere at a price of $100/metric ton (including compression of CO₂ to about 80 bar), which is the DOE target for DAC.

The embodiments described herein are able to reduce the cost of carbon capture, allowing consumers to make a greater profit selling carbon credits and lower the cost of managing greenhouse gas emissions.

Commercialized DAC systems capture CO₂ at a cost of $500-$1000/metric ton for captured CO₂. With a hybrid DAC system, a cost reduction is achieved, reducing the cost of carbon capture to $100/metric ton for a 5× to 10× improvement.

Solids such as hydroxides and amino acids, often used in direct air capture because they do not evaporate, pose a risk for cooling towers as they can easily build up in the water and lead to fouling, thereby reducing performance and reliability of the cooling function. This is not the case with liquid absorbent solvents. Further, challenges were solved with absorbent loss in the cooling tower via a solvent retention system, which adds a substantially solvent-free fluid at the top level, which can simultaneously function as cooling tower makeup if steam condensate is used, and challenges related to the regeneration of low-concentration absorbents in water. By using high quality water as makeup, blowdown requirements were reduced.

By initially targeting geothermal cooling towers, absorbent selection was not limited, as the blowdown can be reinjected into the geothermal reservoir. With these features, substantially reduced operating costs were obtained, which would be more competitive than current DAC solutions.

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Refer now to FIG. 2, which is a partial cutaway of a common cooling tower 200 used in a conventional industrial application. Here, a polyvinyl chloride (PVC) structure is used as a contactor bed 202. A fan 204 operates as an air mover, causing inlet air 206 to move from an upstream side 208 to a downstream side 210 through the contactor bed 202. The fan 204 is in turn powered by a motor 212 driving a drive shaft 214 to a gear reducer 216. To improve fan 204 performance, a fiberglass fan stack 218 acts as a shroud surrounding the fan 204. Input heated process water 220 enters a hot water inlet 222 to a cooling water distribution system 224, which typically utilizes sprayers that aerosolize the heated process water 220. Drift eliminators 226 tend to collect process water 220 mist into droplets (not shown) that fall through the contactor bed 202, where evaporation and cooling occurs, and thence fall into a catchment basin 228. Makeup water 230 is in turn added to the catchment basin 228 to offset evaporative process water 220 to maintain a controlled level 232 of cooled process water 234, which exits the cooling tower 200 through a cooling outlet 236.

Corrugated casing panels 236 operate to shroud the overall cooling tower 200, and confine the inlet air 206 to pass through the contactor bed 202.

As is seen from FIG. 2, the fan 204 moves inlet air 206 through the contactor bed 202 an out through the top of the cooling tower 200. As the inlet air 206 is moving upwards, and the process water 220 is falling downwards, the cooling process is termed as “counter flow”, as the two different flows are in opposite directions. Other implementations are “cross flow”, where the contactor bed is not exactly horizontal.

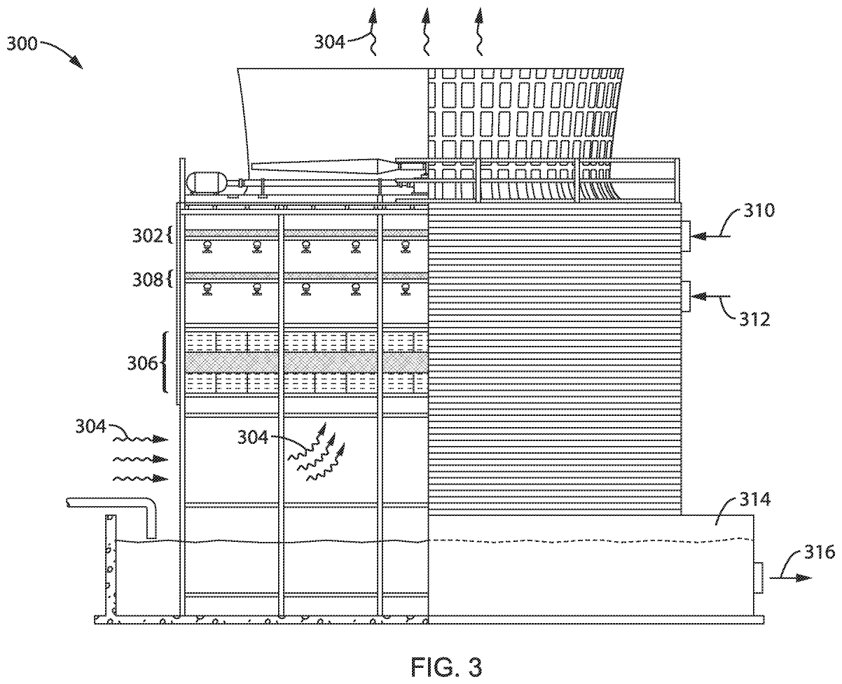

Refer now to FIG. 3, which illustrates a design of a direct air capture (DAC) of carbon dioxide hybrid cooling tower 300 using two liquids with an added solvent retention system 302. The solvent retention system 302 operates down stream from the air flow 304, after the air has passed through the contactor bed 306. The solvent retention system 302 is similar to the cooling water distribution system 308, however the solvent retention system 302 is fed by water 310 without a substantial amount of liquid carbon dioxide solvent.

For carbon capture operation, the cooling water distribution system 308 is fed by a coolant 312 comprising: substantially water, and a liquid carbon dioxide solvent.

During operation, the coolant 312 operates as a traditional water coolant for cooling purposes, but additionally operates as a direct air capture (DAC) of carbon dioxide capture system by directly contacting the air flow 304 with the liquid carbon dioxide solvent present in the coolant 312.

What evaporated liquid carbon dioxide solvent present in the air flow 304 above the cooling water distribution system 308 is captured by the solvent retention system 302, and falls through the contactor bed 306 to the catchment basin 314 to become part of the output cooled process water flow 316.

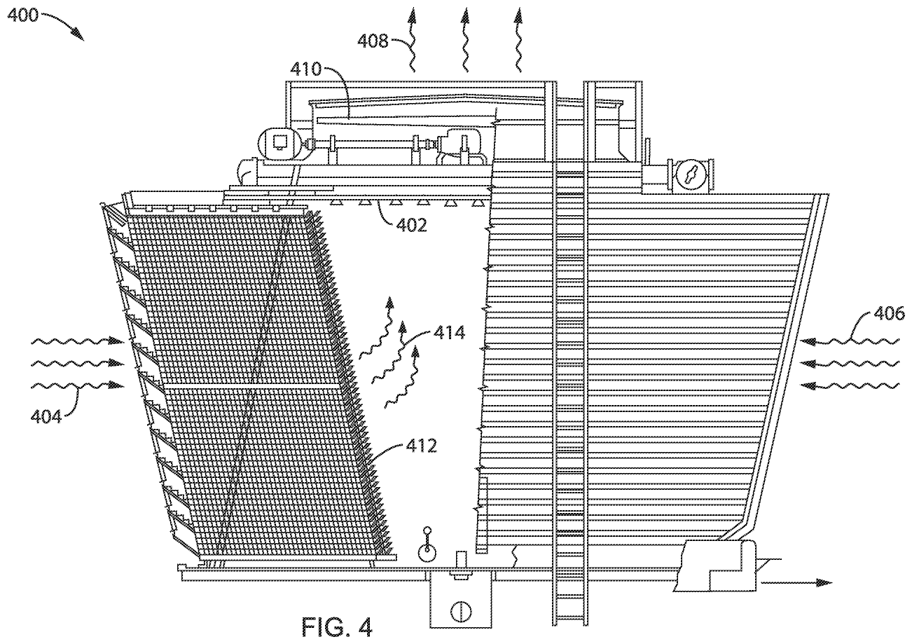

Refer now to FIG. 4, which illustrates a design of a direct air capture (DAC) hybrid cooling tower 400 with an added horizontal solvent retention system 402 in a crossflow configuration. Here, input airflow 404 arrives from the left side and 406 right side, while both are exhausted 408 from the air mover (fan) 410 after passing through the contactor bed 412, shown in cutaway on the left side of the cooling tower 400. In this hybrid system, the solvent retention system 402 is implemented in a horizontal plane. Air flow 414 depicts air that has moved through the contactor bed 412, en route to be exhausted 408.

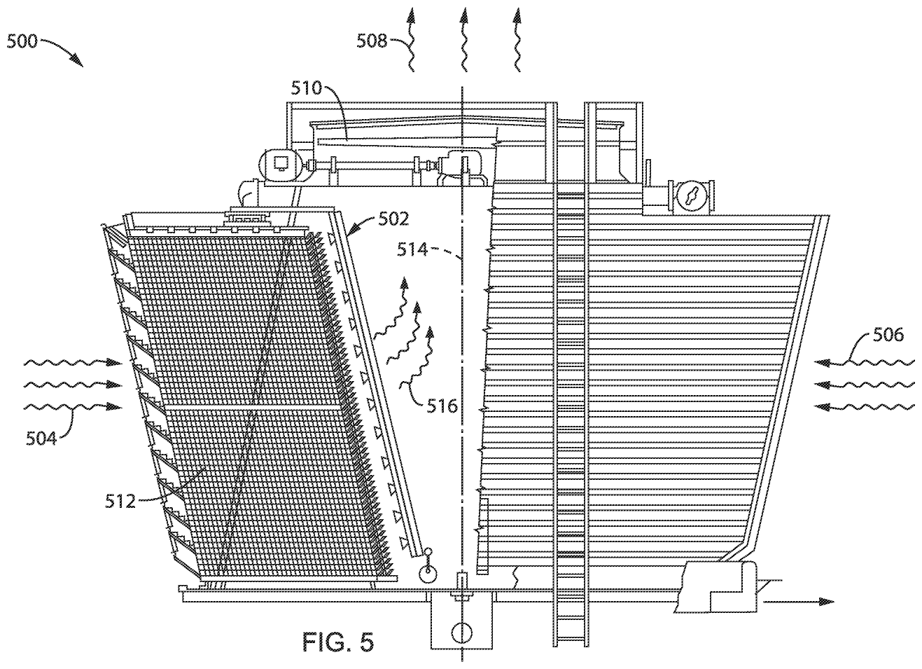

Refer now to FIG. 5, which illustrates a design of a direct air capture (DAC) hybrid cooling tower 500 with an added inclined solvent retention system 502 in a crossflow configuration. Here, input airflow 504 arrives from the left side and 506 right side, while both are exhausted 508 from the air mover (fan) 510 after passing through the contactor bed 512, shown in cutaway on the left side of the cooling tower 500. In this hybrid system, the solvent retention system 502 is implemented in an inclined plane, and would be mirrored about a center line 514 in the cooling tower 500. Air flow 516 depicts air that has moved through the contactor bed 512, then through the inclined solvent retention system 502, en route to be exhausted 508.

In both FIG. 4 and FIG. 5 above, the liquid supplied to the solvent recovery systems is substantially liquid carbon dioxide solvent-free water. Such water also may be used as the makeup water stream 230 previously seen in FIG. 2.

### CONCLUSION

In the foregoing specification, the technology of this disclosure has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

From the description herein, it will be appreciated that the present disclosure encompasses multiple implementations of the technology which include, but are not limited to, the following:

A system for direct air capture (DAC) of CO₂, comprising: a contactor bed comprising an upstream side and a downstream side; an air mover; whereby the air mover causes air to be passed through the contactor bed in an airflow from the upstream side to the downstream side; a solvent retention system disposed on the downstream side of the contactor bed; whereby air sequentially flows initially through the contactor bed and then through the solvent retention system; a coolant transported to the contactor bed; the coolant comprising: substantially water; and a liquid carbon dioxide solvent; whereby the liquid carbon dioxide solvent captures carbon dioxide from the airflow that passes through the contactor bed; whereby makeup water supplied to the solvent retention system substantially retains liquid carbon dioxide solvent as solvent laden makeup water; a catchment basin disposed beneath the contactor bed and the solvent retention system; whereby the coolant and solvent laden makeup water falls to the catchment basin as a cooled solution.

The apparatus or method or system of any preceding or following implementation, wherein a concentration of the liquid carbon dioxide solvent in the coolant is about 1% to 10% by weight, or about 3%.

The apparatus or method or system of any preceding or following implementation, wherein, as the coolant flows through the cooling tower: a temperature of the coolant decreases to form the cooled solution; and the liquid carbon dioxide solvent absorbs carbon dioxide to increase a carbon dioxide concentration of the solvent.

The apparatus or method or system of any preceding or following implementation, wherein the liquid carbon dioxide solvent comprises an amine.

The apparatus or method or system of any preceding or following implementation wherein the liquid carbon dioxide solvent is substantially monoethanolamine (MEA).

The apparatus or method or system of any preceding or following implementation, wherein the liquid carbon dioxide solvent is a liquid carbon dioxide solvent selected from a group monoethanolamine (MEA), methyldiethanolamine (MDEA), diethanolamine (DEA), 2-amino-2-methyl-1-propanol (AMP), and mixtures thereof.

The apparatus or method or system of any preceding or following implementation, wherein the liquid carbon dioxide solvent further comprises an activator.

The apparatus or method or system of any preceding or following implementation, wherein the activator is piperazine or 1-Dimethylamino-2-propanol.

The apparatus or method or system of any preceding or following implementation, wherein the cooling tower comprises a bilevel injection system, and wherein when in operation, the coolant is transported to the contactor bed, and substantially solvent-free water is transported to the solvent retention system.

The apparatus or method or system of any preceding or following implementation, wherein the cooling tower airflow configuration is selected from: crossflow, counterflow, and a combination of crossflow and counterflow.

A system for direct air capture (DAC) of CO₂, comprising: a contactor bed comprising an upstream side and a downstream side; an air mover; whereby the air mover causes air to be passed through the contactor bed in an airflow from the upstream side to the downstream side; a solvent retention system disposed on the downstream side of the contactor bed; whereby air sequentially flows initially through the contactor bed and then through the solvent retention system; a coolant supply in fluid connection with the contactor bed; a water supply in fluid connection with the solvent retention system.

The apparatus or method or system of any preceding or following implementation, wherein the coolant comprises: substantially water; and a liquid carbon dioxide solvent.

The apparatus or method or system of any preceding or following implementation, wherein the liquid carbon dioxide solvent captures carbon dioxide from the airflow that passes through the contactor bed; wherein makeup water supplied to the solvent retention system substantially retains liquid carbon dioxide solvent as solvent laden makeup water.

The apparatus or method or system of any preceding or following implementation, further comprising: a catchment basin disposed beneath the contactor bed and the solvent retention system; whereby the coolant and solvent laden makeup water falls to the catchment basin as a cooled solution.

A method of direct air capture (DAC) of CO₂, comprising the steps of: moving air comprising a component of carbon dioxide sequentially through: a contactor bed comprising an upstream side and a downstream side; and then a solvent retention system disposed on the downstream side of the contactor bed; transporting a coolant to the contactor bed; the coolant comprising: substantially water; and a liquid carbon dioxide solvent; capturing carbon dioxide from the air that passes through the contactor bed by direct air capture with the liquid carbon dioxide solvent; whereby makeup water supplied to the solvent retention system substantially retains liquid carbon dioxide solvent as solvent laden makeup water; providing a catchment basin disposed beneath the contactor bed and the solvent retention system; whereby the coolant and solvent laden makeup water falls to the catchment basin as a cooled solution; and providing an air mover that moves the moving air.

The apparatus or method or system of any preceding or following implementation, wherein a concentration of the liquid carbon dioxide solvent in the coolant is about 1% to 10% by weight, or about 3%.

The apparatus or method or system of any preceding or following implementation, wherein, as the coolant flows through the cooling tower: a temperature of the coolant decreases to form the cooled solution; and the liquid carbon dioxide solvent absorbs carbon dioxide to increase a carbon dioxide concentration of the solvent.

The apparatus or method or system of any preceding or following implementation, wherein the liquid carbon dioxide solvent comprises an amine.

The apparatus or method or system of any preceding or following implementation, wherein the liquid carbon dioxide solvent is substantially monoethanolamine (MEA).

The apparatus or method or system of any preceding or following implementation, wherein the liquid carbon dioxide solvent is a liquid carbon dioxide solvent selected from a group monoethanolamine (MEA), methyldiethanolamine (MDEA), diethanolamine (DEA), 2-amino-2-methyl-1-propanol (AMP), and mixtures thereof.

The apparatus or method or system of any preceding or following implementation, wherein the liquid carbon dioxide solvent further comprises an activator comprising: piperazine or 1-Dimethylamino-2-propanol.

As used herein, the term “implementation” is intended to include, without limitation, embodiments, examples, or other forms of practicing the technology described herein.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C”, within the present disclosure describe where either A, B, or C can be present, or any combination of items A, B and C. Phrasing constructs indicating, such as “at least one of” followed by listing a group of elements, indicates that at least one of these groups of elements is present, which includes any possible combination of the listed elements as applicable.

References in this disclosure referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system, or method.

As used herein, the term “set” refers to a collection of one or more objects. Thus, for example, a set of objects can include a single object or multiple objects.

Relational terms such as first and second, top and bottom, upper and lower, left and right, and the like, may be used solely to distinguish one entity or action from another entity or action without necessarily requiring or implying any actual such relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, apparatus, or system, that comprises, has, includes, or contains a list of elements does not include only those elements but may include other elements not expressly listed or inherent to such process, method, article, apparatus, or system. An element proceeded by “comprises . . . a”, “has . . . a”, “includes . . . a”, “contains . . . a” does not, without more constraints, preclude the existence of additional identical elements in the process, method, article, apparatus, or system, that comprises, has, includes, contains the element.

As used herein, the terms “approximately”, “approximate”, “substantially”, “substantial”, “essentially”, and “about”, or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3º, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term “coupled” as used herein is defined as connected, although not necessarily directly and not necessarily mechanically. A device or structure that is “configured” in a certain way is configured in at least that way, but may also be configured in ways that are not listed.

Benefits, advantages, solutions to problems, and any element(s) that may cause any benefit, advantage, or solution to occur or become more pronounced are not to be construed as a critical, required, or essential feature or element of the technology described herein or any or all the claims.

In addition, in the foregoing disclosure various features may be grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after the application is filed. Accordingly, the reader should consult the application as filed for the original content of the disclosure. Any deletion of content of the disclosure should not be construed as a disclaimer, forfeiture, or dedication to the public of any subject matter of the application as originally filed.

All text in a drawing figure is hereby incorporated into the disclosure and is to be treated as part of the written description of the drawing figure.

The following claims are hereby incorporated into the disclosure, with each claim standing on its own as a separately claimed subject matter.

Although the description herein contains many details, these should not be construed as limiting the scope of the disclosure, but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. A system for direct air capture (DAC) of CO₂, comprising:
(a) a contactor bed comprising an upstream side and a downstream side;
(b) an air mover;
(c) whereby the air mover causes air to be passed through the contactor bed in an airflow from the upstream side to the downstream side;
(d) a solvent retention system disposed on the downstream side of the contactor bed;
(e) whereby air sequentially flows initially through the contactor bed and then through the solvent retention system;
(f) a coolant transported to the contactor bed;
(g) the coolant comprising:
(i) substantially water; and
(ii) a liquid carbon dioxide solvent;
(h) whereby the liquid carbon dioxide solvent captures carbon dioxide from the airflow that passes through the contactor bed;
(i) whereby makeup water supplied to the solvent retention system substantially retains liquid carbon dioxide solvent as solvent laden makeup water;
(j) a catchment basin disposed beneath the contactor bed and the solvent retention system;
(k) whereby the coolant and solvent laden makeup water falls to the catchment basin as a cooled solution.

2. The system of claim 1, wherein a concentration of the liquid carbon dioxide solvent in the coolant is about 1% to 5% by weight, or about 3%.

3. The system of claim 1, wherein as the coolant flows through the cooling tower:
(a) a temperature of the coolant decreases to form the cooled solution; and
(b) the liquid carbon dioxide solvent absorbs carbon dioxide to increase a carbon dioxide concentration of the solvent.

4. The system of claim 1, wherein the liquid carbon dioxide solvent comprises an amine.

5. The system of claim 4, wherein the liquid carbon dioxide solvent is substantially monoethanolamine (MEA).

6. The system of claim 4, wherein the liquid carbon dioxide solvent is a liquid carbon dioxide solvent selected from a group monoethanolamine (MEA), methyldiethanolamine (MDEA), diethanolamine (DEA), 2-amino-2-methyl-1-propanol (AMP), and mixtures thereof.

7. The system of claim 4, wherein the liquid carbon dioxide solvent further comprises an activator.

8. The system of claim 7, wherein the activator is piperazine or 1-Dimethylamino-2-propanol.

9. The system of claim 1, wherein the cooling tower comprises a bilevel injection system, and wherein when in operation, the coolant is transported to the contactor bed, and substantially solvent-free water is transported to the solvent retention system.

10. The system of claim 1, wherein the cooling tower airflow configuration is selected from: crossflow, counterflow, and a combination of crossflow and counterflow.

11. A system for direct air capture (DAC) of CO₂, comprising:
(a) a contactor bed comprising an upstream side and a downstream side;
(b) an air mover;
(c) whereby the air mover causes air to be passed through the contactor bed in an airflow from the upstream side to the downstream side;
(d) a solvent retention system disposed on the downstream side of the contactor bed;
(e) whereby air sequentially flows initially through the contactor bed and then through the solvent retention system;
(f) a coolant supply in fluid connection with the contactor bed;
(g) a water supply in fluid connection with the solvent retention system.

12. The system of claim 11, wherein the coolant comprises:
(a) substantially water; and
(b) a liquid carbon dioxide solvent.

13. The system of claim 12,
(a) wherein the liquid carbon dioxide solvent captures carbon dioxide from the airflow that passes through the contactor bed;
(b) wherein makeup water supplied to the solvent retention system substantially retains liquid carbon dioxide solvent as solvent laden makeup water.

14. The system of claim 13, further comprising:
(a) a catchment basin disposed beneath the contactor bed and the solvent retention system;
(b) whereby the coolant and solvent laden makeup water falls to the catchment basin as a cooled solution.

15. A method of direct air capture (DAC) of CO₂, comprising the steps of:
(a) moving air comprising a component of carbon dioxide sequentially through:
(i) a contactor bed comprising an upstream side and a downstream side; and then
(ii) a solvent retention system disposed on the downstream side of the contactor bed;
(b) transporting a coolant to the contactor bed;
(c) the coolant comprising:
(i) substantially water; and
(ii) a liquid carbon dioxide solvent;
(d) capturing carbon dioxide from the air that passes through the contactor bed by direct air capture with the liquid carbon dioxide solvent;
(e) whereby makeup water supplied to the solvent retention system substantially retains liquid carbon dioxide solvent as solvent laden makeup water;
(f) providing a catchment basin disposed beneath the contactor bed and the solvent retention system;
(g) whereby the coolant and solvent laden makeup water falls to the catchment basin as a cooled solution; and
(h) providing an air mover that moves the moving air.

16. The method of claim 15, wherein a concentration of the liquid carbon dioxide solvent in the coolant is about 1% to 10% by weight, or about 3%.

17. The method of claim 16, wherein as the coolant flows through the cooling tower:
(a) a temperature of the coolant decreases to form the cooled solution; and
(b) the liquid carbon dioxide solvent absorbs carbon dioxide to increase a carbon dioxide concentration of the solvent.

18. The method of claim 17, wherein the liquid carbon dioxide solvent is substantially monoethanolamine (MEA).

19. The method of claim 18, wherein the liquid carbon dioxide solvent is a liquid carbon dioxide solvent selected from a group monoethanolamine (MEA), methyldiethanolamine (MDEA), diethanolamine (DEA), 2-amino-2-methyl-1-propanol (AMP), and mixtures thereof.

20. The method of claim 19, wherein the liquid carbon dioxide solvent further comprises an activator comprising: piperazine or 1-Dimethylamino-2-propanol.
